(19) United States
(12) Patent Application Publication
(10) Pub. No.: US 2019/0039819 A1
(43) Pub. Date: Feb. 7, 2019

(54) AIR-TIGHT CONTAINER FOR STORING REUSABLE FILTER CUPS

(71) Applicant: Christian TREMBLAY, Trois-Rivières (CA)

(72) Inventor: Christian TREMBLAY, Trois-Rivières (CA)

(21) Appl. No.: 16/035,561

(22) Filed: Jul. 13, 2018

Related U.S. Application Data
(60) Provisional application No. 62/540,761, filed on Aug. 3, 2017.

(51) Int. Cl. B65D 85/804; A47J 31/06

(52) U.S. Cl. CPC B65D 85/8046; A47J 31/0689

(57) ABSTRACT

There is provided a container for hermetically storing therein a reusable filter cup enclosed by a cover. The container comprises a housing that defines a cavity for receiving the filter cup and a perimeter seal dimensioned to seat thereon an outer edge of the cover. The container also comprises a retaining member removably securable across the cavity. The retaining member comprises a top seal for sealing an opening of the cover. When the retaining member is in the closed position the outer edge of the cover sealingly engages the perimeter seal and the top seal sealingly engages the cover over the opening so as to hermetically store the filter cup, such that freshness and dryness of the brewing material in the reusable filter cup are preserved and such that the reusable filter cup is conveniently transportable.

### CROSS-REFERENCE TO RELATED APPLICATIONS

The present disclosure claims the benefit of priority from U.S. provisional application No. 62/540,761 filed on Aug. 3, 2017. This document is hereby incorporated by reference in its entirety.

### FIELD OF THE DISCLOSURE

The present disclosure relates to beverage accessories and more particularly to containers for hermetically storing reusable filter cups.

### BACKGROUND OF THE DISCLOSURE

The use of single-cup brewing machines has become increasingly popular. Such brewing machines are designed to brew a single cup of beverage, for example coffee, tea, hot chocolate, etc. Typically, a single-use filter cup is placed in the machine and a brewing liquid, for example hot water, is passed through the filter cup to produce the beverage. There is however growing concern regarding the amount of waste generated by disposal of such single-use cups, many of which cannot be reused or recycled.

Reusable filter cups are known and are an environmentally friendly alternative which can reduce the amount of waste generated.

### SUMMARY OF THE DISCLOSURE

It would thus be desirable to be provided with a means to store reusable filter cups, for example in an air-tight sealed container.

According to an aspect of the present disclosure, there is provided a container for hermetically storing therein a reusable filter cup enclosed by a cover, comprising:
a housing having a base and a circular wall extending therefrom, the housing defining a cavity for receiving the reusable filter cup;
a housing having a base and a circular wall extending therefrom, the housing defining a cavity for receiving the reusable filter cup;
a perimeter seal extending from a circular rim defined by an extremity of the circular wall opposite the base, the perimeter seal dimensioned to seat thereon an outer edge of the cover;
a retaining member removably securable across the cavity and movable between an opened position and a closed position, the retaining member comprising a top seal for sealing an opening of the cover,
wherein when the retaining member is in the opened position the filter cup can be inserted or removed from the housing, and when the retaining member is in the closed position the outer edge of the cover sealingly engages the perimeter seal and the top seal sealingly engages the cover over the opening so as to hermetically store the filter cup.

By storing filter cups in the container of the present disclosure, the product contained in the filter cup, for example ground coffee, remains fresh and dry. The filter cups can be filled in advance, stored for later use and be conveniently transportable.

### BRIEF DESCRIPTION OF THE DRAWINGS

In the following figures, which represent by way of example only, various embodiments of the disclosure:

FIG. 1 is a perspective view of the container in a closed position, according to an exemplary embodiment.

FIG. 2 is a perspective view of the container of FIG. 1, in an opened position.

FIG. 3 is a perspective view of the container of FIG. 1, in an opened position, with top and perimeter seals removed.

FIG. 4 is a perspective view of the container of FIG. 1, in an opened position, receiving a reusable filter cup.

FIG. 5 is a perspective view of the container of FIG. 1, in an opened position comprising a reusable filter cup inserted therein.

FIG. 6 is a front elevation view of the container of FIG. 1, in a closed position.

### DETAILED DESCRIPTION OF THE DISCLOSURE

As used in this specification and the appended claims, the singular forms “a”, “an” and “the” include plural references unless the content clearly dictates otherwise. Thus for example, a composition containing “a compound” includes a mixture of two or more compounds. It should also be noted that the term “or” is generally employed in its sense including “and/or” unless the content clearly dictates otherwise.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including”, “having” and their derivatives. Finally, terms of degree such as “substantially”, “about” and “approximately” as used herein mean a reasonable amount of deviation of the modified term such that the end result is not significantly changed. These terms of degree should be construed as including a deviation of ±10% of the modified term if this deviation would not negate the meaning of the word it modifies.

The definitions and embodiments described in particular sections are intended to be applicable to other embodiments herein described for which they are suitable as would be understood by a person skilled in the art.

For example, the perimeter seal is made of a flexible material.

For example, the top seal is made of a flexible material.

For example, the perimeter seal and the top seal are made of the same flexible material.

For example, the retaining member is movable between the opened position and the closed position via a hinge.

For example, the retaining member comprises a first end connected to a first outer portion of the circular wall and a second end removably securable to a second outer portion of the circular wall.

For example, the second end comprises a locking member removably securable to a projection extending about the second outer portion of the circular wall.

For example, the retaining member is movable in the closed position by pressing down the second end of the retaining member so as to engage the locking member with the projection.

For example, the retaining member is movable in the opened position by pressing up the second end of the retaining member so as to disengage the locking member from the projection.

For example, the locking member is a clip.

For example, the top seal is circular.

For example, the top seal is located on a central portion of the retaining member.

For example, the circular wall is tapered.

The following examples are non-limitative and are used to better exemplify the materials and processes of the present disclosure.

### EXAMPLES

Referring now to the exemplary figures, the container 10 is configured to hermetically store a reusable filter cup 26.

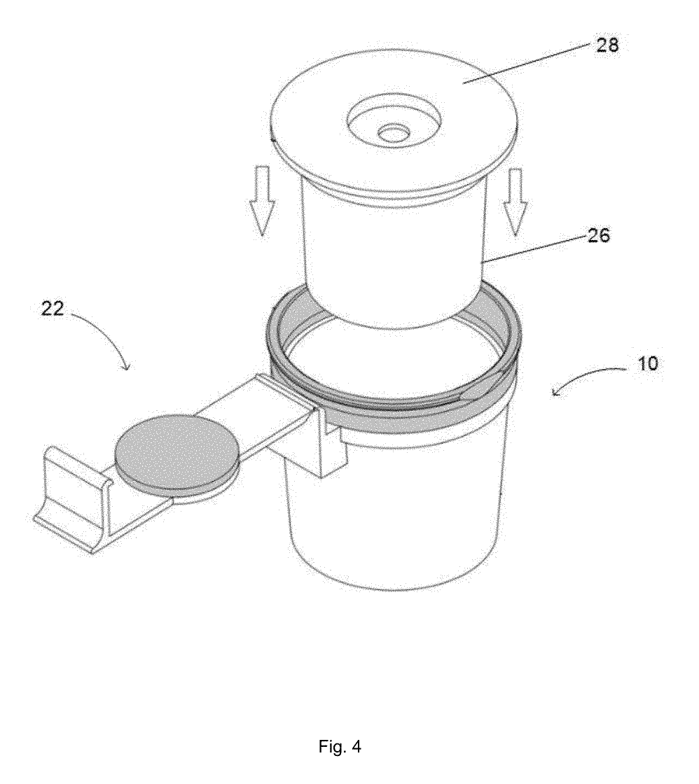

The reusable filter cup 26 contains the material to be brewed, e.g. coffee or tea, and is enclosable by a cover 28. As shown in FIG. 4, the cover 28 comprises an opening 30 through which a brewing liquid (e.g. hot water) is dispensed or injected. The filter cup 26 comprises one or more apertures covered by a filter (not shown) through which the brewed liquid (e.g. coffee) exits. The filter cup can be any type of reusable filter cup, for example a reusable filter cup configured to be inserted in single-cup brewing machine. The reusable filter cup 26 shown in FIG. 4 has a cylindrical body however it will be understood that any type of reusable filter cup whose body can fit within the housing can be used, so long as the outer edge of the cover can sealingly engage with the perimeter seal. For example, when inserted into the housing 12, the bottom of the reusable filter cup does not touch the inner portion of the base 16 of the housing.

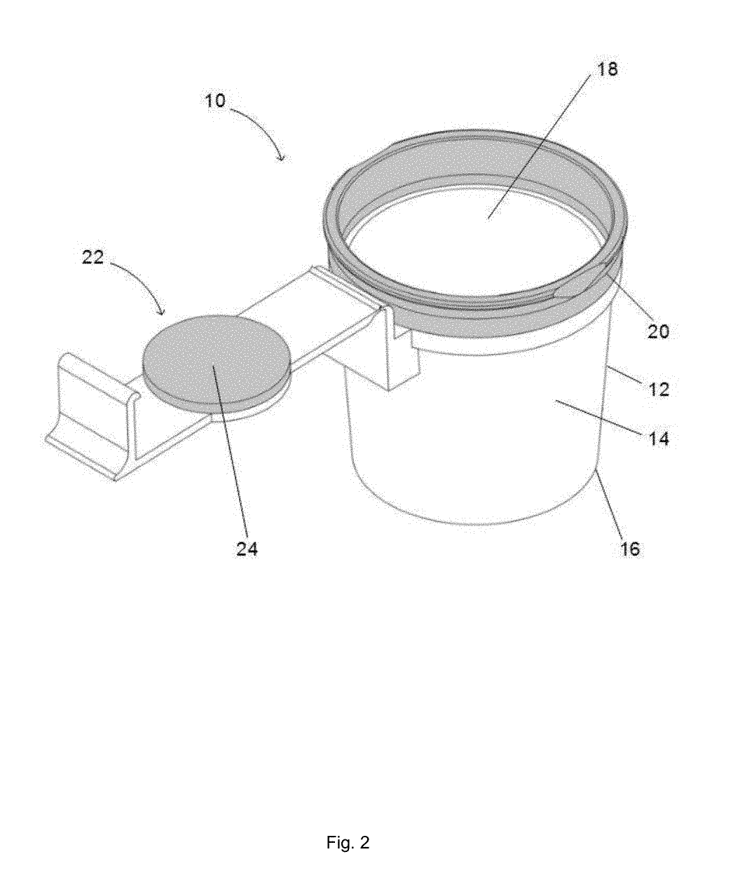

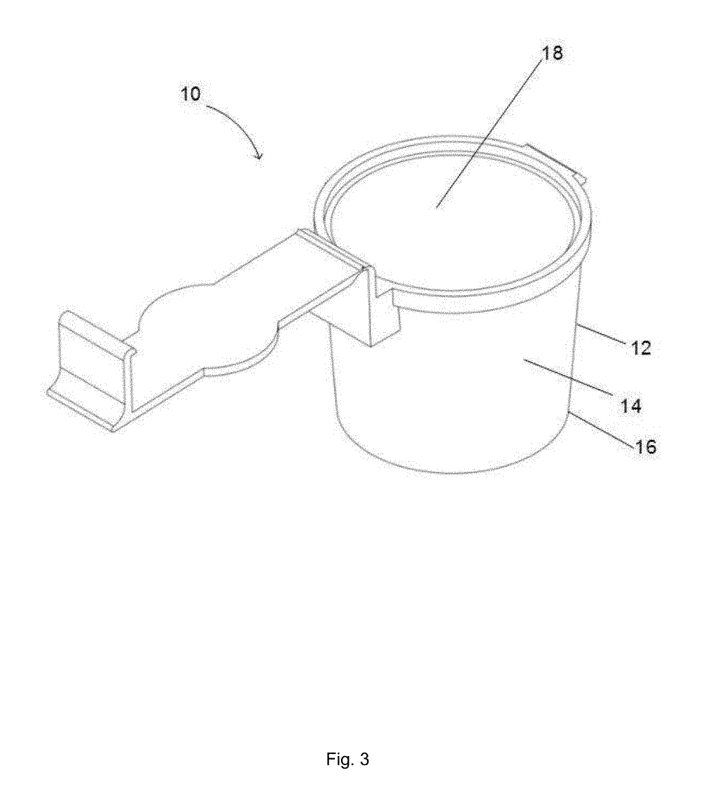

As shown in FIGS. 2 and 3, the container 10 comprises a housing 12 which has a base 16 and a circular wall 14 extending therefrom, optionally extending substantially vertically therefrom. The circular wall is slightly tapered toward the base however it will be understood that other shapes may be contemplated. For instance, the circular wall may be cylindrical such that the diameter of the base and of the circular is the same. The housing defines a cavity 18 for receiving the filter cup 26. The housing can be formed of any suitable material, for example a plastic material.

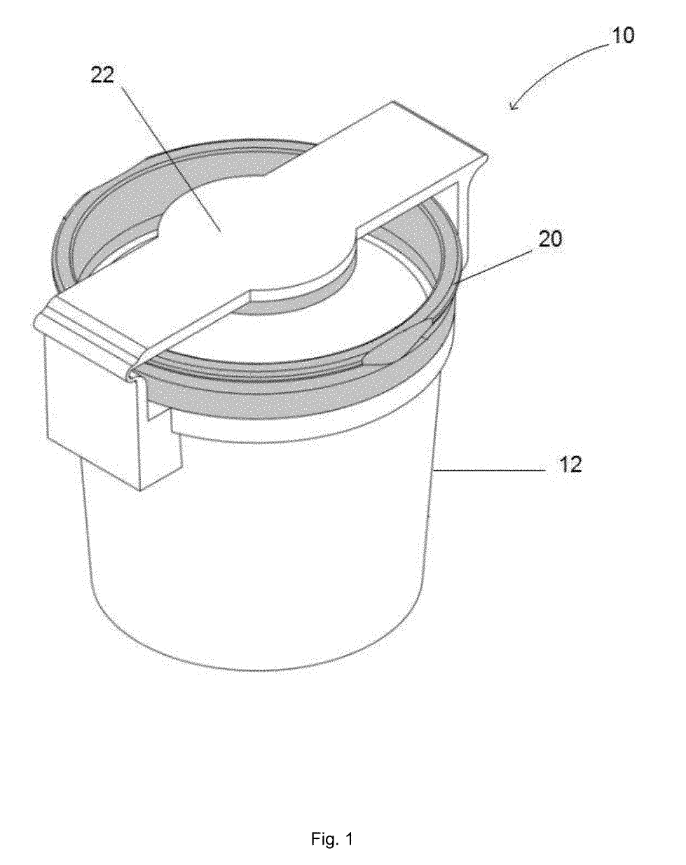

With reference to FIGS. 1, 2 and 4-6, a perimeter seal 20 extends from a circular rim defined by an extremity of the circular wall 14 opposite the base 16 of the housing. The perimeter seal 20 is dimensioned to seat thereon an outer edge of the cover 28 of the reusable filter cup 26. In an embodiment, the perimeter seal is made of a flexible material. For example, the perimeter seal 20 is made of a flexible material comprising natural rubber, synthetic rubber, silicone, and mixtures thereof.

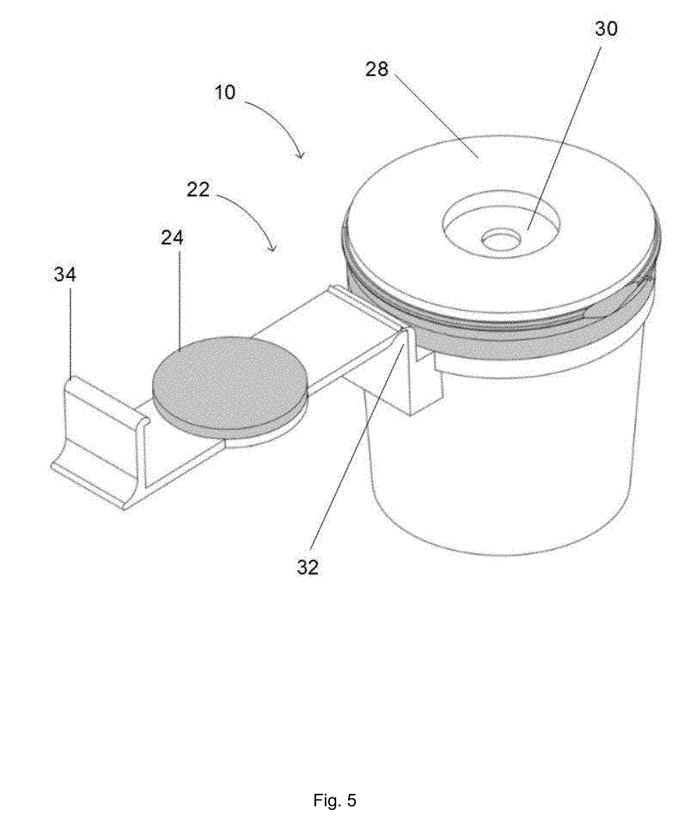

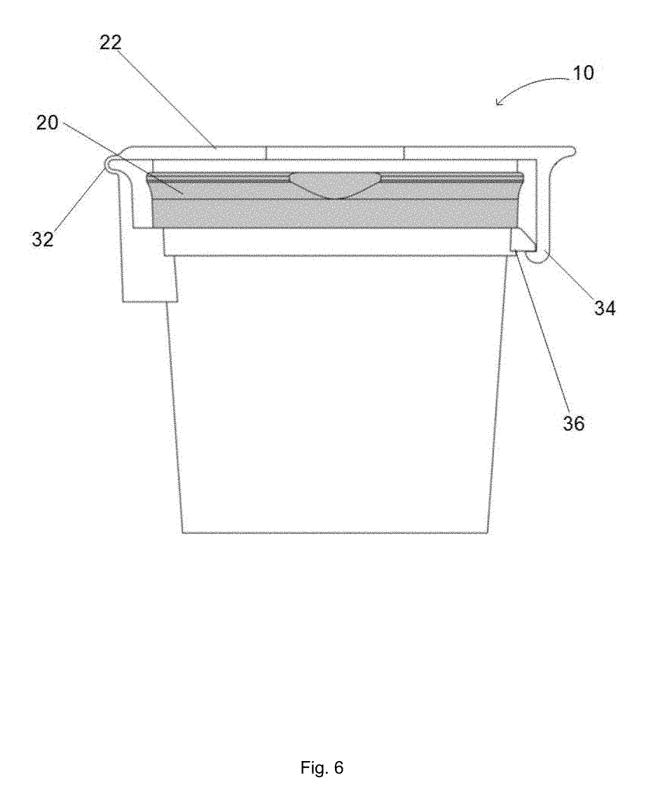

In addition, the container 10 comprises a retaining member 22 that is removably securable across the cavity of the housing, and is movable between an opened position, as shown in FIGS. 2, 4 and 5, and a closed position, as shown in FIGS. 1 and 6. Referring now to FIG. 5, the retaining member 22 comprises a first end secured to a portion of the outer circular wall adjacent the perimeter seal 20, for example via a hinge 32. The second end of the retaining member 22 comprises a locking member 34, for example a hook like configuration, designed to engage a projection 36 located on a portion of the outer circular wall opposite the first end of the retaining member 22.

For example, the retaining member 22 has a length that is substantially similar or slightly greater than the diameter of the housing 12. It will be understood that other known securing means can be used to secure the retaining member 22 over the filter cup cover 22. In FIGS. 1 to 6, the retaining member has a narrow strap-like shape. A person skilled in the art will appreciate that other shapes may be contemplated. For example, the retaining member 22 may be circular and have an outer circumference similar to that of the filter cup cover 28 and/or perimeter seal 20. For example, the retaining member 22 may be a narrow band or strap. The retaining member 22 can be formed of any suitable material, for example a plastic material, for example the same material used for the housing.

Referring more specifically to FIG. 2 and FIG. 5, the retaining member also comprises a top seal 24 for sealing the opening 30 of the filter cup cover. For example, the top seal 24 is circular and is positioned about mid-length of the retaining member 22, for example at a central portion of the retaining member. It will be understood that the diameter, shape and position of the top seal can vary so long as it is configured to completely cover the opening 30 of the filter cup cover to as to form a seal. In an embodiment, the top seal 24 is made of a flexible material. For example, the top seal is made of a flexible material comprising natural rubber, synthetic rubber, silicone, and mixtures thereof. For example, the perimeter seal and top seal can be made of the same flexible material.

In use, when the retaining member 22 is in an opened position, the user can insert a reusable filter cup 26 into the cavity 18, as shown in FIGS. 4 and 5. To hermetically secure the reusable filter cup 26 within the cavity, the user lifts the retaining member 22 over and across the cavity and presses the second end of the retaining member 22 downwardly until the locking member 34 on the second end of the retaining member 22 securely engages the projection 36, see for example FIG. 6. When the retaining member 22 is in a closed position, as shown in FIG. 6, the content of the reusable filter cup 26 is hermetically stored. More specifically, the outer edge of the cover 28 of the filter cup presses against the perimeter seal 20 of the container thus forming a seal. In conjunction, the top seal 24 on the retaining member presses against the opening 30 of the filter cup cover thus also forming a seal around the opening 30.

When the reusable filter cup 26 is hermetically stored in the container, its freshness and dryness are preserved and it can be easily transported. When the user wishes to remove the reusable filter cup 26 from the container 10, the locking member 34 is disengaged from the projection 36. For example when the locking member 34 is a hook, upward pressure can be applied thus unhooking the hook from the projection 36.

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

What is claimed is:

1. A container for hermetically storing therein a reusable filter cup enclosed by a cover, comprising:
a housing having a base and a circular wall extending therefrom, the housing defining a cavity for receiving the reusable filter cup;
a perimeter seal extending from a circular rim defined by an extremity of the circular wall opposite the base, the perimeter seal dimensioned to seat thereon an outer edge of the cover;
a retaining member removably securable across the cavity and movable between an opened position and a closed position, the retaining member comprising a top seal for sealing an opening of the cover,
wherein when the retaining member is in the opened position the filter cup can be inserted or removed from the housing, and when the retaining member is in the closed position the outer edge of the cover sealingly engages the perimeter seal and the top seal sealingly engages the cover over the opening so as to hermetically store the filter cup.

2. The container of claim 1, wherein the perimeter seal is made of a flexible material.

3. The container of claim 1, wherein the top seal is made of a flexible material.

4. The container of claim 2, wherein the retaining member is movable between the opened position and the closed position via a hinge.

5. The container of claim 4, wherein the retaining member comprises a first end connected to a first outer portion of the circular wall and a second end removably securable to a second outer portion of the circular wall.

6. The container of claim 5, wherein the second end comprises a locking member removably securable to a projection extending about the second outer portion of the circular wall.

7. The container of claim 6, wherein the retaining member is movable in the closed position by pressing down the second end of the retaining member so as to engage the locking member with the projection.

8. The container of claim 6, wherein the retaining member is movable in the opened position by pressing up the second end of the retaining member so as to disengage the locking member from the projection.

9. The container of claim 8, wherein the locking member is a clip.

10. The container of claim 9, wherein the top seal is circular.

11. The container of claim 10, wherein the top seal is located on a central portion of the retaining member.

12. The container of claim 11, wherein the circular wall is tapered.
